(19) United States
(12) Patent Application Publication
(10) Pub. No.: US 2019/0171691 A1
(43) Pub. Date: Jun. 6, 2019

(54) A METHOD OF MODE ORDER DETERMINATION FOR ENGINEERING STRUCTURAL MODAL IDENTIFICATION

(71) Applicant: Dalian University of Technology, Dalian City, Liaoning Province (CN)

(72) Inventors: Chunxu QU, Dalian City, Liaoning Province (CN); Tinghua YI, Dalian City, Liaoning Province (CN); Hongnan LI, Dalian City, Liaoning Province (CN)

(21) Appl. No.: 16/321,183

(22) PCT Filed: Mar. 6, 2018
(86) PCT No.: PCT/CN2018/078134

§ 371 Date: Jan. 28, 2019

(30) Foreign Application Priority Data
Apr. 14, 2017 (CN) 201710236267.4

(51) Int. Cl. G06F 17/16; G01M 5/00

(52) U.S. Cl. CPC G06F 17/16; G01N 29/12; G01M 5/0066

(57) ABSTRACT

The presented invention belongs to the technical field of data analysis for structural health monitoring, and relates to a method of the mode order determination for the modal identification of engineering structures. The presented invention first calculates the structural natural frequencies for every order by eigensystem realization algorithm. Then the modal responses for every natural frequency are extracted. After obtaining the square mean root of modal responses, the modal response contribution index (MRCI) is calculated by summation of square mean root for every degree-of-freedom. The relation map between mode order and MRCI is drawn. The mode order is determined by the obvious gap between two adjacent MRCI according to the relation map. This order is also the truncated order of singular matrix in the eigensystem realization algorithm, which is useful to identify other modal parameters accurately.

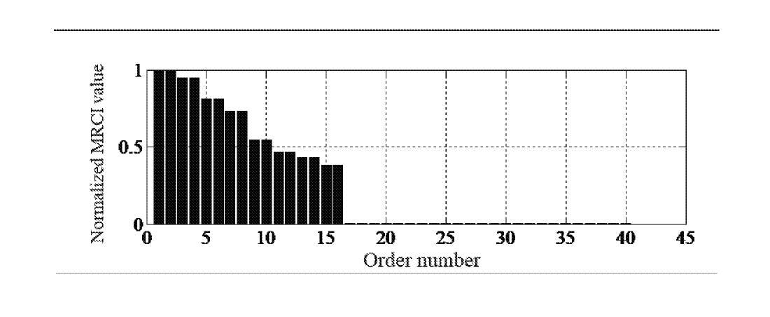

### TECHNICAL FIELD

The presented invention belongs to the technical field of data analysis for structural health monitoring, and relates to a method of the mode order determination for the modal identification of engineering structures.

### BACKGROUND

The variation of modal parameters of engineering structures is caused by structural property changing. Therefore, the structural performance can be evaluated by the identified modal parameters. In practical engineering, the exact excitation information is hard to be obtained. Hence, the identification method only based on the structural response (operational modal analysis, OMA) is more applicable. The subspace method in time domain is always used.

When the subspace method is utilized to identify the modal parameters, the mode order should be determined. Inaccurate mode order can bring in large error to the identified modes. There are many researches on the mode determination method. K. J. Astron et al. determined the order by residual sum of squares, which performed the table search by F criterion, and calculated to obtain the order. The Japanese statistician H. Akaike proposed the Akaike's information criterion (AIC) based on information theory, which considered the model applicability complexity, and obtain the order by minimization. W. Q. Zhang et al. derived the F test threshold value based on F test and AIC, and applied it to auto-regressive and auto-regressive and moving average model. T. Ding et al. transferred the state-space model to the observability canonical form to obtain the linear regression equation. The mode order is determined by the dimension changing of the determinant of the data multiplication matrix. W. Yang et al. analyzed the relation between noise-signal ratio and singular entropy, and presented the mode order determination method by the progressive characteristic of the singular entropy increment. However, these methods cannot determine the mode order by the obvious threshold value for practical engineering, which causes the inaccurate mode order and results in the inaccuracy of the structural properties. Therefore, it is important to determine the mode order during the modal identification process.

### SUMMARY

The objective of the presented invention is to provide a new mode order determination method for engineering structures, which can solve the order determination problem during the modal identification process.

The technical solution of the present invention is as follows:

The mode order determination method during modal identification process is derived. The method first decomposes the Hankel matrix constructed by the impulse response with environment noise by singular value decomposition. The rank of the singular value matrix is the assumed mode order, and the structural natural frequencies can be obtained. Then the modal responses can be calculated based on the modal superposition using the obtained frequencies. The scalar for each degree-of-freedom is calculated by square mean root of modal responses. Modal response contribution index (MRCI) is then obtained by the summation of the scalars for all degree-of-freedom. The relation map between mode order and MRCI is plotted, where the horizontal axis denotes the mode order and the vertical axis represents the MRCI. From this map, the mode order is determined by the obvious gap between two adjacent MRCI. This order is also the truncated order of singular matrix in the eigensystem realization algorithm. Other modal parameters can be identified.

The procedures of the mode order determination method for the modal identification of engineering structures are as follows:

Step 1: sample and process the impulse response.

The structural impulse responses yₖ are collected. The Hankel matrix H(k−1) and H(k) are built by yₖ:

$$H ( k ) = ( \begin{matrix}{y}_{k} & {y}_{k + 1} & … & {y}_{k + cH - 1} \\ {y}_{k + 1} & {y}_{k + 2} & … & {y}_{k + cH} \\ … & … & … & … \\ {y}_{k + rH - 1} & {y}_{k + rH} & … & {y}_{k + rH + cH - 2}\end{matrix} )$$

where k+i represents the k+i time point; the number from k to k+rH+cH−2 is the number of time points for the time history. H(k−1) can be obtained by replacing k with k−1. H(k−1) is then decomposed by singular matrix decomposition as follows:

H(k−1)=UΓ²V^{T}

where Γ is singular value matrix; U and V are unitary matrix.

Step 2: obtain the modal shape matrix

The rank cH of singular matrix is assumed to be the structural mode order. Then the eigenvalue λⱼ can be obtained by eigensystem realization algorithm. The relation equation between modal responses and structural responses is built using N eigenvalues, and the modal shape matrix Φⱼ is obtained as follows:

$$( \begin{matrix}{Φ}_{1} & {Φ}_{1} & … & {Φ}_{N}\end{matrix} ) = ( \begin{matrix}{y}_{1} & {y}_{2} & … & {y}_{p}\end{matrix} ) {( \begin{matrix}{λ}_{1} & {λ}_{1}^{2} & … & {λ}_{1}^{p} \\ {λ}_{2} & {λ}_{2}^{2} & … & {λ}_{2}^{p} \\ ⋮ & ⋮ & ⋱ & ⋮ \\ {λ}_{N} & {λ}_{N}^{2} & … & {λ}_{N}^{p}\end{matrix} )}^{+}$$

where “⁺” is the generalized inverse; p=rH+cH−1 is the p^{th} time point.

Step 3: Obtain the modal response for the j^{th} mode and the square mean root of the modal response for the j^{th} mode.

The j^{th} modal response Y_{p,j} is expressed as follows:

Y_{p,j}=(y_{1,j}y_{2,j} . . . y_{p,j})=Φⱼ(λⱼλⱼ² . . . λⱼ^{p})

The expression for the scalar, i.e. the square mean root of the j^{th} modal response, is:

εⱼ=sqrt(Y_{p,j}Y_{p,j}^{H})

Step 4: Obtain the mode order.

The j^{th} MRCI is obtained by the summation of the scalars for all degree-of-freedom as follow:

$$MRCI ( j ) = {\sum }_{r = 1}^{m} {ɛ}_{j} ( r )$$

where r denotes the number of degree-of-freedom.

The relation map between mode order and MRCI is drawn, where the horizontal axis denotes the mode order and the vertical axis represents the normalized MRCI by divided by the maximization of MRCI. The mode order is determined by the obvious gap between two adjacent MRCI.

The advantage of the invention is that the mode order is obtained by MRCI and measurement, which has simple procedures and does not need the iterative calculation. The obtained accurate mode order is useful to identify the accurate structural modal parameters.

### DESCRIPTION OF DRAWINGS

The sole FIGURE is the relation between mode order and MRCI

### DETAILED DESCRIPTION

The present invention is further described below in combination with the technical solution.

The numerical example of 8 degree-of-freedom in-plane lumped-mass model is employed. The mass for each floor and stiffness for each story are 1.1×10⁶ kg and 862.07×10⁶ N/m, respectively. The Rayleigh damping ratios of first two modes are 5%. The model is excited by an impulse, and the free decayed response is contaminated by 20% of the variance of the free vibration response. The measurement is the inter-story drift. The procedures are described as follows:

(1) Set rH=150, cH=130, k=1. The time history y from the 1^{st} to 279^{th} time point is used to contribute Hankel matrix H(k−1) and H(k).

$$H ( k ) = ( \begin{matrix}{y}_{k} & {y}_{k + 1} & … & {y}_{k + cH - 1} \\ {y}_{k + 1} & {y}_{k + 2} & … & {y}_{k + cH} \\ … & … & … & … \\ {y}_{k + rH - 1} & {y}_{k + rH} & … & {y}_{k + rH + cH - 2}\end{matrix} )$$

Where k+i represents the k+i time point, i=0 . . . rH+cH+k−2; the number from k to k+rH+cH−2 is the number of time points for the time history.

(2) Make singular value decomposition for Hankel matrix H(k−1):

H(k−1)=UΓ²V^{T}

where Γ is singular value matrix; U and V are unitary matrix; the dimension of Γ 130×130.

(3) Assume that the mode order is 130, i.e. the rank of singular value matrix. The eigenvalues λⱼ can be obtained by eigensystem realization algorithm.

(4) Select 40 eigenvalues from the 130 eigenvalues to be analyzed. The modal shape matrix Φⱼ is calculated by the expression between modal responses and structural responses:

$$( \begin{matrix}{Φ}_{1} & {Φ}_{1} & … & {Φ}_{N}\end{matrix} ) = ( \begin{matrix}{y}_{1} & {y}_{2} & … & {y}_{279}\end{matrix} ) {( \begin{matrix}{λ}_{1} & {λ}_{1}^{2} & … & {λ}_{1}^{279} \\ {λ}_{2} & {λ}_{2}^{2} & … & {λ}_{2}^{279} \\ ⋮ & ⋮ & ⋱ & ⋮ \\ {λ}_{40} & {λ}_{40}^{2} & … & {λ}_{40}^{279}\end{matrix} )}^{+}$$

(5) Calculate the j^{th} modal response Y_{279,j}, where j=1 . . . 40:

Y_{279,j}=(Y_{1,j}Y_{2,j} . . . y_{279,j}=Φⱼ(λⱼλⱼ² . . . λⱼ²⁷⁹)

(6) Solve the square mean value of the j^{th} modal response:

εⱼ=sqrt(Y_{279,i}Y_{279,j}^{H})

where the dimension of the vector εⱼ is 8×1.

(7) Sum the square mean values of the j^{th} modal response for every degree-of-freedom to obtain the MRCI for the j^{th} mode:

$$MRCI ( j ) = {\sum }_{r = 1}^{8} {ɛ}_{j} ( r )$$

(8) Drawn the relation between mode order and MRCI, where the horizontal axis denotes the mode order and the vertical axis represents the normalized MRCI by divided by the maximization of MRCI as shown in the sole FIGURE. In the sole FIGURE, SV denotes the relation between mode order and singular values, which is used to compare with MRCI. From the sole FIGURE, the obvious gap is happened between 16^{th} order and 17^{th} order. The mode order is determined to be 16.

Due to the state-space model, the modal parameters are exhibited as conjugate sequence. The numerical example has 8 degree-of-freedom, so the real order of the state-space model is 16. Therefore, the proposed invention method can identify the mode order precisely.

We claims:

1. The procedures of the mode order determination method for the modal identification of engineering structures are as follows:
Step 1: Sample and process the impulse response;
The structural impulse responses yₖ are collected; The Hankel matrix and H(k−1) and H(k) are built by yₖ:
$$H ( k ) = ( \begin{matrix}{y}_{k} & {y}_{k + 1} & … & {y}_{k + cH - 1} \\ {y}_{k + 1} & {y}_{k + 2} & … & {y}_{k + cH} \\ … & … & … & … \\ {y}_{k + rH - 1} & {y}_{k + rH} & … & {y}_{k + rH + cH - 2}\end{matrix} )$$
where k+i represents the k+i time point; the number from k to k+rH+cH−2 is the number of time points for the time history; H(k−1) can be obtained by replacing k with k−1; H(k−1) is then decomposed by singular matrix decomposition as follows:
H(k−1)=UΓ²V^{T}
where Γ is singular value matrix; U and V are unitary matrix;
Step 2: obtain the modal shape matrix
The rank cH of singular matrix is assumed to be the structural mode order; Then the eigenvalue λⱼ can be obtained by eigensystem realization algorithm; The relation equation between modal responses and structural responses is built using N eigenvalues, and the modal shape matrix Φⱼ is obtained as follows:
$$( \begin{matrix}{Φ}_{1} & {Φ}_{1} & … & {Φ}_{N}\end{matrix} ) = ( \begin{matrix}{y}_{1} & {y}_{2} & … & {y}_{p}\end{matrix} ) {( \begin{matrix}{λ}_{1} & {λ}_{1}^{2} & … & {λ}_{1}^{p} \\ {λ}_{2} & {λ}_{2}^{2} & … & {λ}_{2}^{p} \\ ⋮ & ⋮ & ⋱ & ⋮ \\ {λ}_{N} & {λ}_{N}^{2} & … & {λ}_{N}^{p}\end{matrix} )}^{+}$$
where “⁺” is the generalized inverse; p=rH+cH−1 is the p^{th} time point;
Step 3: Obtain the modal response for the j^{th} mode and the square mean root of the modal response for the j^{th} mode;
The j^{th} modal response Y_{p,j} is expressed as follows:
Y_{p,j}=(y_{1,j}y_{2,j} . . . y_{p,j})=Φⱼ(λⱼλⱼ² . . . λⱼ^{p})
The expression for the scalar, i.e. the square mean root of the j^{th} modal response, is:
εⱼ=sqrt(Y_{p,j}Y_{p,j}^{H})
Step 4: Obtain the mode order;
The j^{th} MRCI is obtained by the summation of the scalars for all degree-of-freedom as follow:
$$MRCI ( j ) = {\sum }_{r = 1}^{m} {ɛ}_{j} ( r )$$
where r denotes the number of degree-of-freedom;
The relation map between mode order and MRCI is drawn, where the horizontal axis denotes the mode order and the vertical axis represents the normalized MRCI by divided by the maximization of MRCI; The mode order is determined by the obvious gap between two adjacent MRCI.
